(19) United States
(12) Patent Application Publication
(10) Pub. No.: US 2014/0266013 A1
(43) Pub. Date: Sep. 18, 2014

(54) SWITCHED VOLTAGE BOOSTER

(71) Applicant: C.E. NIEHOFF & CO., Evanston, IL (US)

(72) Inventors: James Becker, Crystal Lake, IL (US); Stoyan Borissov Bekiarov, Chicago, IL (US)

(73) Assignee: C.E. NIEHOFF & CO., Evanston, IL (US)

(21) Appl. No.: 13/953,988

(22) Filed: Jul. 30, 2013

Related U.S. Application Data
(60) Provisional application No. 61/782,426, filed on Mar. 14, 2013.

(51) Int. Cl. H02J 7/00

(52) U.S. Cl. CPC H02J 7/007
USPC 320/107; 307/31; 320/109; 320/162

(57) ABSTRACT

An electrical system comprises a battery charger which charges or otherwise provides electrical power to an electrical subsystem via a switched-booster circuit. A control device, included in the electrical system, operates a switch module to controllably bypass a voltage-booster circuit according to the voltage of the electrical subsystem and/or the electrical current through the switched-booster circuit. The electrical system may further include additional electrical subsystems and the control device may be further configured to control the voltage-booster circuit.

### CROSS REFERENCE TO RELATED APPLICATIONS

The present patent application is a formalization of a previously filed co-pending provisional patent application entitled “Switched Voltage Booster,” filed Mar. 14, 2013, as U.S. patent application Ser. No. 61/782,426 by the inventor(s) named in this application. This patent application claims the benefit of the filing date of the cited provisional patent application according to the statutes and rules governing provisional patent applications, particularly 35 USC §119 and 37 CFR §1.78. The specification and drawings of the cited provisional patent application are specifically incorporated herein by reference.

### COPYRIGHT

A portion of the disclosure of this patent document contains material which is subject to copyright protection. The owner has no objection to the facsimile reproduction by anyone of the patent disclosure, as it appears in the Patent and Trademark Office files or records, but otherwise reserves all copyright rights whatsoever.

### FIELD OF INVENTION

his invention is related to an electrical system including a battery charger operative to provide electrical power to a first electrical subsystem via a switched-booster circuit including a switch module and a voltage-booster circuit, and a control device configured to ascertain a first voltage of the first electrical subsystem and/or a first electrical current through the switched-booster circuit and to apply a control signal to the switch module according to the measured first voltage and/or first electrical current.

### BACKGROUND

The present invention discloses an electrical system, such as a vehicle electrical system, comprising a battery charger, such as a generator, operable to charge or otherwise deliver electrical power to a first electrical subsystem via a switched-booster circuit. The switched-booster circuit includes a voltage-booster circuit and a switch module. The switch module is coupled with the voltage-booster circuit and it may be controllably switched so as to effectively shunt the voltage-booster circuit according to a first voltage of the first electrical subsystem and/or first electrical current through the switched-booster circuit. A control device, included in the electrical system, achieves this by applying a control signal to the switch module. In particular, the control device, which is coupled with the switched-booster circuit and/or first electrical subsystem, measures or otherwise ascertains the first voltage of the first electrical subsystem and/or first electrical current through the switched-booster circuit, and applies a control signal to the switch module to engage/disengage the voltage-booster circuit. The electrical system may further include a second electrical subsystem and the control device may be further configured to control the voltage-booster circuit.

When there is loss of voltage, or otherwise a condition causing voltage decrease between the battery charger and first electrical subsystem, the control device utilizes the switched-booster circuit to ensure that the first electrical subsystem receives electrical power efficiently. For instance, in an application where the first electrical subsystem is connected to the battery charger via a long electrical cable, voltage loss over the electrical cable could be controllably recovered or ignored via the switched-booster circuit according to different operating conditions.

In a preferred embodiment, the control device operates the switched-booster circuit to turn on the voltage-booster circuit, and switch off the switch module, in order to boost the output voltage of the battery charger when the first voltage is less than or equal to a first predetermined voltage and the first electrical current is greater than or equal to a first predetermined electrical current and less than or equal to a second predetermined electrical current. This embodiment refers to when the first electrical subsystem consumes electrical current within a predetermined range of electrical currents and its voltage is at or below a predetermined voltage. Accordingly, the control device applies a switch off signal to the switch module allowing the voltage-booster circuit to increase the voltage of the battery charger.

In another preferred embodiment, the control device operates the switched-booster circuit, via the switch module, to effectively shunt the voltage-booster circuit when the first voltage is greater than or equal to a first predetermined voltage and the first electrical current is less than a first predetermined electrical current. This embodiment refers to when the first electrical subsystem requires little or no electrical current and its voltage is at or above a predetermined voltage. Accordingly, the control device applies a switch on signal to the switch module and effectively shunting the voltage-booster circuit.

In yet another preferred embodiment, the control device operates the switched-booster circuit, via the switch module, to effectively shunt the voltage-booster circuit when the first voltage is less than or equal to a first predetermined voltage and the first electrical current is greater than a second predetermined electrical current. This embodiment refers to when the first electrical subsystem draws substantial amount of electrical current and its voltage is at or below a predetermined voltage. Accordingly, the control device applies a switch on signal to the switch module and effectively shunts the voltage-booster circuit.

Although, the control device and voltage-booster circuit may operate independently, in a preferred embodiment, the control device maybe further configured to control the voltage-booster circuit. In particular, a processor included in the control device is may be further configured to control the operation of the voltage-booster circuit, known to artisans of ordinary skill, in addition to the operation of the switch module. The switch module may include one or more mechanical relays and semiconductor switches, such as those described in Jabaji et al., U.S. Pat. No. 7,432,613 entitled “Self-Protective High-Current Low-Loss Bi-Directional Semiconductor Switch Module and Method of Operation” incorporated herein by reference in its entirety.

Various electrical systems, such as a vehicle electrical system, are typically comprised of a battery charger such as a generator, electrical loads, and an electrical power storage device such as a battery. The battery operates to deliver electrical power during the time when the generator is not operating, so as to provide the electrical power required by the electrical loads. When the vehicle engine is operating, the generator, driven by the engine, operates to deliver electrical power to the electrical loads and charges the battery. Larger more complex vehicle electrical systems are designed so that the electrical system comprises two or more electrical subsystems. Each of these electrical subsystems comprises of at least an electrical load and a battery. The electrical load may include one or a combination of electronic devices, a starter motor, a heating element, an air conditioning unit, a compressor, a cooling fan, a pump, to name a few examples. Monitoring and control of voltages of the electrical subsystems are of paramount importance.

In an illustrative example of a large vehicle electrical system, consider the one that includes a first and second electrical subsystem. The first electrical subsystem comprises a first electrical load and first battery. The second electrical subsystem comprises a second electrical load and second battery. Furthermore, consider the embodiment where the first electrical subsystem is spatially located at a large distance from the generator. The generator supplies electrical power to both electrical subsystems. Electrical power cables are commonly used to connect the generator to the electrical subsystems. Such electrical power cables, although having small electrical resistance, nevertheless introduce a reduction in voltage over their lengths.

Long electrical power cables are common in large vehicle electrical systems and conventional voltage-booster circuits are commonly used to compensate for the loss of voltage over such long electrical power cables. However, certain operating conditions warrant maintaining direct connection between the generator and electrical subsystem regardless of the voltage loss. It is, therefore, desirable to controllably switch in and out the voltage-booster circuit so as to provide optimal electrical power to the electrical subsystem.

Although in the above example the first and second electrical subsystems utilized long electrical power cables, the associated voltage drops may be caused by undersized cables even though they are of short lengths. In yet other applications, control of voltages of the first and/or second electrical subsystems is desirable regardless of spatial limitations of the vehicle electrical system. For instance, in an application where two different types of batteries are used, a difference between the voltages of the first and second electrical subsystems may be desirable. The control device of the present invention operates to controllably switch the voltage-booster circuit so as to provide electrical output power from the generator at different voltages depending on the vehicle electrical system and operating conditions.

Although various systems have been proposed which touch upon some aspects of the above problems, they do not provide solutions to the existing limitations in providing electrical power with switchable voltage-boosting circuit to one or more electrical subsystems. For example, Hu et al., U.S. Pat. App. No. 20120166697 discloses an electronic device with power output function which includes an interface for connecting with an external power supply or a small electronic device. The electronic device further includes a battery, a boost circuit, a switch circuit, and a charging circuit. When the external power supply is connected to the electronic device through a first cable, the switch circuit is closed to allow the external power supply to charge the battery through the first cable, the interface, the switch circuit, and the charging circuit. When the small electronic device is connected to the electronic device through a second cable, the boost circuit is enabled to boost the power voltage of the battery to allow the battery to charge the small electronic device through the boost circuit, the interface, and the second cable. However, in Hu's electronic device the switch circuit does not effectively shunt the boost circuit and furthermore the boost circuit boosts the battery voltage regardless of the operating conditions.

Andrea et al., U.S. Pat. No. 8,143,856 discloses a bi-directional inverter-charger which includes a bridge rectifier and DC-to-DC conversion components. The inverter-charger may be connected between an alternating current source, e.g., an AC line, and a direct current source, e.g., a battery pack. The DC-to-DC conversion components may include boost and buck circuits that are switchably configured between a charge mode and an inverter mode such that common components are used in both charge and inverter configurations. In the charge configuration, a full wave rectified signal from the H-bridge is up converted by the boost circuit, and the buck circuit controls charge current to the direct current source. In the inverter configuration, the boost circuit up converts the direct current voltage source, and the buck circuit controls the current and its form to the bridge circuit so that the bridge circuit may be connected directly with the AC source. However, Andrea's bi-directional inverter-charger is not configured for and does not operate to switchably boost the voltage of the battery charger according to the operating condition.

Nakajima, U.S. Pat. App. No. 20090128098 discloses a pulse generating circuit which includes a boosting circuit which boosts power source voltage supplied from an external primary battery and produces boosted voltage higher than the power source voltage, a secondary battery to be charged with the boosted voltage, a pulse circuit which generates a pulse, a switch element connected between the secondary battery and the pulse circuit, and a control circuit which enables the boosting circuit and switches off the switch element during a charge period for charging the secondary battery with the boosted voltage, and disenables the boosting circuit and switches on the switch element during a discharge period for discharging the boosted voltage contained in the secondary battery. However, Nakajima's pulse generating circuit does not operate to controllably boost battery charger voltage according to the operating conditions of the associated electrical subsystem.

Feng, U.S. Pat. No. 6,060,861 discloses a car-used spare power system quick charging device which includes a switch, a boosting circuit, a detecting circuit, an indicating circuit, an unstable circuit, a pulse cutting circuit and multiple charging batteries. The detecting circuit serves to detect the voltage state of the charging battery. The indicating circuit serves to indicate the voltage state of the charging battery detected by the detecting circuit. The switch is used to switch the charging/discharging modes. When the charging battery is detected to be in middle or low voltage state, the boosting circuit serves to boost the charging battery into high voltage. The charging battery charges/discharges the car battery by way of pulse so as to protect the charging battery from damage due to over-heating and make the charging battery 100% release voltage. However, in Feng's charging device the switch does not operate to switchably shunt the boosting circuit in accordance with the operating conditions.

Electrical systems, comprising of battery chargers and one or more electrical subsystems, may require voltage boosting circuits due to the configuration of the electrical system. For instance, a large vehicle electrical system employs multiple electrical subsystems which are charged or otherwise powered by a generator. In such electrical systems, the generator output voltage is reduced due to a variety of factors, including but not limited to use of long electrical cables. It is often necessary to incorporate a voltage-booster circuit to recover the lost voltage.

As a simple, yet efficient, alternative to existing technologies, the present invention offers a switched voltage booster. The configuration and method of operation of conventional voltage-booster circuits is improved by incorporating a control device and switch module to controllably boost the voltage of the battery charger according to the operating conditions.

### SUMMARY

The present invention discloses an electrical system, including method of operation, comprising a battery charger which charges or otherwise delivers electrical power to a first electrical subsystem via a switched-booster circuit. The switched-booster circuit includes a voltage-booster circuit and a switch module. A control device operates the switch module to controllably bypass the voltage-booster circuit according to the voltage of the first electrical subsystem and/or electrical current through the switched-booster circuit. The control device may further operate to control the voltage-booster circuit, and the electrical system may further include a second electrical subsystem.

In one aspect, an electrical system comprises a first electrical subsystem, a switched-booster circuit comprising a switch module and a voltage-booster circuit wherein the switch module is coupled with the voltage-booster circuit, a battery charger coupled with the first electrical subsystem via the switched-booster circuit, and a control device coupled with at least one of the first electrical subsystem and switched-booster circuit, wherein the control device is configured to ascertain at least one of a first voltage of the first electrical subsystem and first electrical current through the switched-booster circuit, and apply a control signal to the switch module according to at least one of the first voltage and first electrical current.

Preferably, the electrical system comprises a vehicle electrical system. Preferably, the first electrical subsystem comprises at least one of a battery and an electrical load. Preferably, the battery charger comprises a generator. Preferably, the control signal comprises one of a step signal and a modulated signal. Preferably, the step signal comprises one of a switch on and a switch off signal. Preferably, the step signal is a switch on signal when the first voltage is greater than or equal to a first predetermined voltage and the first electrical current is less than a first predetermined electrical current. Preferably, the step signal is a switch off signal when the first voltage is less than or equal to a first predetermined voltage and the first electrical current is greater than or equal to a first predetermined electrical current and less than or equal to a second predetermined electrical current. Preferably, the step signal is a switch on signal when the first voltage is less than or equal to a first predetermined voltage and the first electrical current is greater than a second predetermined electrical current.

Preferably, the control device is further configured to control the voltage-booster circuit.

Preferably, the electrical system further comprises a second electrical subsystem coupled with the battery charger. Preferably, the second electrical subsystem comprises at least one of a battery and an electrical load.

In another aspect, a method for controlling an electrical system is disclose wherein the system comprises a first electrical subsystem, a switched-booster circuit comprising a switch module and a voltage-booster circuit wherein the switch module is coupled with the voltage-booster circuit, and a battery charger coupled with the first electrical subsystem via the switched-booster circuit, wherein the method comprises ascertaining at least one of a first voltage of the first electrical subsystem and first electrical current through the switched-booster circuit, and applying a control signal to the switch module according to at least one of the first voltage and first electrical current.

Preferably, the method further comprises controlling the voltage-booster circuit.

In another aspect, a control device coupled with at least one of a first electrical subsystem and a switched-booster circuit, said switched-booster circuit comprising a switch module and a voltage-booster circuit wherein the switch module is coupled with the voltage-booster circuit, and wherein a battery charger is coupled with the first electrical subsystem via the switched-booster circuit, said control device comprising a controller, wherein the controller is configured to measure at least one of a first voltage of the first electrical subsystem and first electrical current through the switched-booster circuit, via at least one of a first sense line and a second sense line, and apply a control signal, via a control line, to the switch module according to at least one of the first voltage and first electrical current.

Preferably, the control signal comprises one of a step signal and a modulated signal. Preferably, the step signal comprises one of a switch on and a switch off signal. Preferably, the step signal is a switch on signal when the first voltage is greater than or equal to a first predetermined voltage and the first electrical current is less than a first predetermined electrical current. Preferably, the step signal is a switch off signal when the first voltage is less than or equal to a first predetermined voltage and the first electrical current is greater than or equal to a first predetermined electrical current and less than or equal to a second predetermined electrical current. Preferably, the step signal is a switch on signal when the first voltage is less than or equal to a first predetermined voltage and the first electrical current is greater than a second predetermined electrical current.

Preferably, the control device is further configured to control the voltage-booster circuit.

Preferably, the battery charger is further coupled with a second electrical subsystem.

In another aspect, a method for controlling a switched-booster circuit is disclosed wherein the switched-booster circuit comprises a switch module and a voltage-booster circuit wherein the switch module is coupled with the voltage-booster circuit, and wherein a battery charger is coupled with the first electrical subsystem via the switched-booster circuit, wherein the method comprises measuring at least one of a first voltage of the first electrical subsystem and first electrical current through the switched-booster circuit, via at least one of a first sense line and a second sense line, and applying a control signal, via a control line, to the switch module according to at least one of the first voltage and first electrical current.

Preferably, the method further comprises controlling the voltage-booster circuit, via a controller.

### BRIEF DESCRIPTION OF THE DRAWINGS

FIG. 1 shows a block diagram of an electrical system comprising a battery charger coupled with a first electrical subsystem via a switched-booster circuit and a control device controllably switches the switch module to engage/disengage the voltage-booster circuit, within the switched-booster circuit, in response to the voltage of the first electrical subsystem and/or electrical current through the switched-booster circuit according to a preferred embodiment.

FIG. 2 shows a schematic diagram of the electrical connections between the various components within the electrical system of FIG. 1 which further includes a second electrical subsystem according to a preferred embodiment.

FIG. 3 is a flow diagram of one preferred method of controlling the electrical system of FIG. 1 or FIG. 2.

FIG. 4 is a flow diagram of one preferred method of controlling a switched-booster circuit.

FIG. 5 is a flow diagram of one preferred method of controlling a switched-booster circuit.

FIG. 6 is a flow diagram of one preferred method of controlling a switched-booster circuit.

FIG. 7 is a flow diagram of one preferred method of operation of the control device of FIG. 1 or FIG. 2 that maybe implemented on a processor, included in the control device, further detailing the conditions under which the control device switches the switch module to engage/disengage and to further control the switched-booster circuit.

### DETAILED DESCRIPTION OF THE PRESENTLY PREFERRED EMBODIMENTS

FIG. 1 depicts a block diagram of a preferred embodiment of an electrical system 100 comprising a battery charger 102 coupled with a first electrical subsystem 108 via a switched-booster circuit 104. The battery charger 102 may be a generator and the first electrical subsystem 108 may include an electrical energy source, such as a battery, and an electrical load. The switched-booster circuit 104 comprises a switch module 106 coupled with a voltage-booster circuit 116. The electrical system 100 further comprises a control device 114 which controllably switches the switch module 106 to engage/disengage the voltage-booster circuit 116, within the switched-booster circuit 104, in response to the voltage of the first electrical subsystem 108 and/or electrical current through the switched-booster circuit 104 according to a preferred embodiment. The control device 114 further comprises an I/O port 130 whereby system parameters can be communicated with the electrical system 100. The electrical system 100 may further include a second electrical subsystem and the control device 114 may be further configured to control the operation of the voltage-booster circuit 116, as explained in more detail below.

The battery charger 102 is connected to the first electrical subsystem 108 via a line 116, a switched-booster circuit 104, and a line 110. The control device 114 is connected to and in communication with the first electrical subsystem 108 via a sense lines 124. The control device 114 measures the voltage of the first electrical subsystem 108 via the sense line 124. The control device 114 is connected to and in communication with the switched-booster circuit 104 via a sense lines 120 and one or two control lines 112 and 122 depending on whether the control device 114 also controls the operation of the voltage-booster circuit 116.

In this preferred embodiment, the control device 114 controls the operations of both the switch module 106 and the voltage-booster circuit 116, via the control lines 112 and 122, respectively. Specifically, the control device 114 measures the electrical current through the switched-booster circuit 104 via the sense line 120 and applies a control signal to the switch module 106 via the control line 112 according to at least one of the measured voltage of the first electrical subsystem 108 and electrical current through the switched-booster circuit 104. In this preferred embodiment, the control device 114 controls the operation of the voltage-booster circuit 116 via the control line 122 by turning the voltage-booster circuit 116 on when the switch module 106 is off and turning it off when the switch module 106 is switched on.

A voltage-booster circuit, also known to artisans of ordinary skill as boost converter, is a DC-to-DC power converter circuit which provides an output voltage greater than its input voltage. The circuit commonly includes semiconductor switches, such as diodes and transistors, and electrical energy storage elements, such as capacitors, inductors, or a combination thereof. Filters, made of capacitors and/or inductors, may also be used to reduce output voltage ripple. In a preferred embodiment, the voltage-booster circuit 116 comprises an inductor, a diode, and a semiconductor switch. The control device 114 utilizes the control line 122 to switch the semiconductor switch to boost the output voltage of the battery charger 102.

The first electrical subsystem 108 comprises an electrical energy source which may be a battery, a capacitor, a DC/DC converter, a fuel cell or a combination thereof. The first electrical subsystem 108 further comprises an electrical load which may be one or a combination of a heating element, an air conditioning unit, a compressor, a cooling fan, a pump, to name a few examples. The switch module 106 may be one or more of a metal oxide semiconductor field effect transistor, a diode, a Schottky diode, and a mechanical relay switch. The switch module 106 may be packaged separately or integrated in a single housing. A bi-directional switch module, such as the one disclosed in the commonly owned U.S. Pat. No. 7,432,613 entitled “SELF-PROTECTIVE HIGH-CURRENT LOW-LOSS BI-DIRECTIONAL SEMICONDUCTOR SWITCH MODULE AND METHOD OF OPERATION” incorporated herein by reference in its entirety, may also be utilized.

The control device 114 includes a controller which may be analog or digital such as a microprocessor. In one preferred embodiment, the microprocessor is a 68HC08 processor having internal flash memory available from Freescale of Austin, Tex. It is contemplated that the processor may be a combination of individual discrete or separate integrated circuits packaged in a single housing or it may be fabricated in a single integrated circuit. The control device 114 is configured to measure one or a combination of a first voltage of the first electrical subsystem 108 and first electrical current through the switched-booster circuit 104, and to apply one or more control signals to the switch module 106 and/or voltage-booster circuit 116 in response to these measurements.

In a preferred embodiment, the electrical system 100 is a vehicle electrical system and the battery charger 102 is a generator which provides electrical power at a regulation voltage V_{R} to the first electrical subsystem 108. In this preferred embodiment, the generator comprises a voltage regulator (not shown but known to artisans of ordinary skill) which regulates the output voltage V_{G} of the generator at the regulation voltage V_{R}. For an exemplary vehicle electrical system, the regulation voltage V_{R} of the generator may be maintained, via the voltage regulator, at a predetermined voltage V_{C1} equal to 14V, for instance.

The line 110 represents an electrical cable whose electrical resistance is such that there is a measurable voltage difference ΔV₁ between the generator output voltage V_{G} and the voltage V₁ of the first electrical subsystem 108. The control device 114 ascertains the voltage V₁ of the first electrical subsystem 108 and first electrical current I₁ through the switched-booster circuit 104 and applies a control signal to the switch module 106 according to the voltage V₁ and electrical current I₁ to controllably compensate for the voltage difference ΔV₁. In other words, the voltage compensation maybe based on both the voltage V₁ and electrical current I₁. The voltage difference ΔV₁ is a function of the first electrical current through the switched-booster circuit 104 and may be as high as 1.5V over the length of the line 110. In one preferred embodiment, the control device 114 switches on/off the switch module 106 and effectively enables/disables the voltage-booster circuit 116 as a function of the voltage V₁ and electrical current I₁.

The control device 114 applies one or more control signals which comprise a step signal or a modulated signal depending on the switching scheme. The step signal may be a switch on or a switch off signal which is applied to the switch module 106. The modulated signal may be a pulse-width-modulation signal with duty cycle D, known to artisans of ordinary skill.

According to one embodiment, the control device 114 applies a switch on signal to the switch module 106 when the first voltage V₁ is greater than or equal to a first predetermined voltage V_{C1} and the first electrical current I₁ is less than a first predetermined electrical current I_{C1}, for instance, 5 A. According to another embodiment, the control device 114 applies a switch off signal to the switch module 106 when the first voltage V₁ is less than or equal to a first predetermined voltage V_{C1} and the first electrical current I₁ is greater than or equal to a first predetermined electrical current I_{C1} and less than or equal to a second predetermined electrical current I_{C2}, for instance, 50 A. According to yet another embodiment, the control device 114 applies a switch on signal to the switch module 106 when the first voltage V₁ is less than or equal to a first predetermined voltage and the first electrical current I₁ is greater than a second predetermined electrical current I_{C2}. Where the control device 114 operates to further control the voltage-booster circuit 116, the control device 114 applies a modulated signal to the semiconductor switch (not shown) included in the voltage-booster circuit 116.

FIG. 2 shows a schematic diagram 200 of the electrical connections between the various components within the electrical system of FIG. 1 which includes more than one electrical subsystem according to a preferred embodiment. The electrical system includes a control device 202, a generator 242, a first electrical subsystem 220, a second electrical subsystem 214, and a switched-booster circuit 236 commonly grounded at 230. The switched-booster circuit 236 comprises a switch module 216 and a voltage-booster circuit 240. The switch module 216 comprises a mechanical relay 212. The voltage-booster circuit 240 comprises a semiconductor switch 238, an inductor 234, and a diode 232. The first electrical subsystem 220 comprises a first electrical load 222 which is connected to a first battery 218. The second electrical subsystem 214 comprises a second electrical load 226 which is connected to a second battery 228. The control device 202 is connected to and in communication with the generator 242, voltage-booster circuit 240, switch module 216, first electrical subsystem 220, and second electrical subsystem 214, via lines 250, 252, 208, 210, 206, 204, and 248.

According to this preferred embodiment, the control device 202 measures a first voltage V₁ of the first electrical subsystem 220 via the line 204. The control device 202 further measures a first electrical current I₁ via the line 206. The control device 202 compares the first voltage V₁ and first electrical current I₁ with a first predetermined voltage V_{C1} and a first predetermined electrical current I_{C1} which are stored in its memory and applies a control signal to the switch module 216, via the line 210 according to the first voltage V₁ and first electrical current I₁. The control signal may be a step signal or a modulated signal. The step signal comprises either a switch on (close relay) or a switch off (open relay) signal. The modulated signal may be a pulse-width-modulation signal with duty cycle D, known to artisans of ordinary skill.

In one instance, when the first voltage V₁ is greater than or equal to a first predetermined voltage V_{C1}, for example 14V, and the first electrical current I₁ is less than a first predetermined electrical current I_{C1}, for example 5 A, the control device 202 applies a control signal to the switch module 216, via the line 210, to close the relay switch 212. The switch module 216 effectively shunts the voltage-booster circuit 240. Alternatively, the control device 202 may at the same time apply a control signal to the voltage-booster circuit 240 via the line 208 to turn off the voltage-booster circuit 240. As a result, the voltage-booster circuit 240 is disabled. In another instance, when the first voltage V₁ is less than or equal to the first predetermined voltage V_{C1} and the first electrical current I₁ is greater than or equal to the first predetermined electrical current I_{C1} and less than or equal to a second predetermined electrical current I_{C2}, the control device 202 applies a control signal to the switch module 216, via the line 210, to open the relay switch 212. The voltage-booster circuit 240 can now operate to boost the output voltage of the generator 242. Alternatively, the control device 202 may at the same time apply a control signal to the voltage-booster circuit 240 via the line 208 to turn on the voltage-booster circuit 240. As a result, the voltage-booster circuit 240 is enabled. In one preferred embodiment, the control device 202 may apply a phase modulated signal to the semiconductor switch 238 via the line 208 to fully operate the voltage-booster circuit 240. In another instance, when the first voltage V₁ is less than or equal to the first predetermined voltage V_{C1} and the first electrical current I₁ is greater than a second predetermined electrical current I_{C2}, for example 50 A, the control device 202 applies a control signal to the switch module 216, via the line 210, to close the relay switch 212. The switch module 216 effectively shunts the voltage-booster circuit 240. Alternatively, the control device 202 may at the same time apply a control signal to the voltage-booster circuit 240 via the line 208 to turn off the voltage-booster circuit 240. As a result, the voltage-booster circuit 240 is disabled.

Utilizing the vehicle electrical system 200 described above, one embodiment of the operation of the control device 202 is now described. The generator 242 is coupled to the first electrical subsystem 220, via the switched-booster circuit 236 and line 224, and to the second electrical subsystem 214, via the line 246. The line 224 represents an electrical component, such as an electrical cable, which can introduce a voltage drop between the output voltage V_{G} of the generator 242 and first voltage V₁ of the first electrical subsystem 220. This voltage drop may be due to the electrical current I₁ to the first electrical subsystem 220 or it may be due to the nature of the electrical component 224 which causes such voltage drop. As such, the operation of the control device 202 is not limited to loss of voltage over long electrical cables.

The control device 202 is configured to measure a variety of parameters including the first voltage V₁, the generator output voltage V_{G}, and the first electrical current I₁. The control device 202 applies a control signal to the switch module 216 to close the switch 212 to allow high charging first electrical current I₁ to the first electrical subsystem 220 which includes the first battery 218. As the first battery 218 charges up, the first electrical current I₁ is decreased, but the first voltage V₁ of the first electrical subsystem 220 continues to suffer from the voltage drop and the first battery 218 charges only to about 12.5V-13.0V instead of 14V. The control device 202 compares the first voltage V₁ with a first predetermined voltage V_{C1} and compares the first electrical current I₁ with a first and a second predetermined electrical current I_{C1} and I_{C2}. When the first voltage V₁ is less than or equal to a first predetermined voltage V_{C1}, say 14V, and the first electrical current I₁ is greater than or equal to a first predetermined electrical current I_{C2}, say 5 A, and less than or equal to a second predetermined electrical current I_{C2}, say 50 A, the control device 202 applies a control signal to the switch module 216 via the line 210 to open the switch 212, and the voltage-booster circuit 240 begins operating at its rated current capacity to charge up the first battery 218 to the regulated 14V setting. If the generator output voltage V_{G} suddenly drops during this stage of operation, it signifies a large first electrical load 222 has just been applied to the first battery 218, and the control device 202 applies a control signal to the switch module 216 to close the switch 212 and the voltage-booster circuit 240 is subsequently disabled allowing the generator 242 and/or the second battery 228 to supply the higher electrical current demand by the first electrical subsystem 220. When there is low electrical current demand, for instance I₁ is less than 5 A, and the first voltage V₁ is greater than or equal to V_{C1}, the control device 202 applies a control signal to the switch module 216 to close the switch 212 and disabling the voltage-booster circuit 240 based on the fact that such low electrical current do not cause excessive voltage drops.

FIG. 3 is a flow diagram 300 of one preferred method of controlling an electrical system such as those depicted in FIGS. 1 and 2, the latter being used as reference to fully describe the method. According to this embodiment, the method comprises ascertaining at least one of a first voltage V₁ of the first electrical subsystem 108 and first electrical current I₁ through the switched-booster circuit 104 at 302. The quantities V₁ and I₁ are ascertained by direct measurement such those described in relation to FIG. 2 or other indirect means such as receiving them from the electrical system's communication interface. The method further comprises applying a control signal to the switch module 106 according to at least one of the first voltage V₁ and first electrical current I₁ at 306. The method further comprises controlling the voltage-booster circuit 116 at 310.

FIG. 4 is a flow diagram 400 of one preferred method of controlling a switched-booster circuit such as that depicted in FIG. 2. According to this embodiment, the method comprises measuring at least one of a first voltage V₁ of the first electrical subsystem 220 and first electrical current I₁ through the switched-booster circuit 236, via at least one of a first sense line 204 and a second sense line 206 at 402. The method further comprises applying a switch on signal, via a control line 210, to the switch module 216 when the first voltage V₁ is greater than or equal to a first predetermined voltage V_{C1} and the first electrical current I₁ is less than a first predetermined electrical current I_{C1} at 406.

FIG. 5 is a flow diagram 500 of one preferred method of controlling a switched-booster circuit such as that depicted in FIG. 2. According to this embodiment, the method comprises measuring at least one of a first voltage V₁ of the first electrical subsystem 220 and first electrical current I₁ through the switched-booster circuit 236, via at least one of a first sense line 204 and a second sense line 206 at 502. The method further comprises applying a switch off signal, via a control line 210, to the switch module 216 when the first voltage V₁ is less than or equal to a first predetermined voltage V_{C1} and the first electrical current I₁ is greater than or equal to a first predetermined electrical current I_{C1} and less than or equal to a second predetermined electrical current I_{C2} at 506.

FIG. 6 is a flow diagram 600 of one preferred method of controlling a switched-booster circuit such as that depicted in FIG. 2. According to this embodiment, the method comprises measuring at least one of a first voltage V₁ of the first electrical subsystem 220 and first electrical current I₁ through the switched-booster circuit 236, via at least one of a first sense line 204 and a second sense line 206 at 602. The method further comprises applying a switch on signal, via a control line 210, to the switch module 216 when the first voltage V₁ is less than or equal to a first predetermined voltage V_{C1} and the first electrical current I₁ is greater than a second predetermined electrical current I_{C2} at 606.

FIG. 7 is a flow 700 diagram of one preferred method of operation of the control device of FIG. 1 or 2 that maybe implemented on a processor, included in the control device, further detailing the conditions under which the control device operates on a switched-booster circuit to controllably switch on and off the switch module and turn off and on the voltage-booster circuit in response to the operating conditions. Additionally, the control device 202 is further configured to determine the status of the generator 242 via a sense line 250 and a second voltage V₂ of a second electrical subsystem 214 to complement its method of controlling the switched-booster circuit 236. Various system parameters, such as predetermined voltages and electrical current values, can either be stored in the processor's RAM/ROM or communicated to the control device via its I/O port.

Upon power up at 702, the processor branches at 704 and determines if the generator 242 is on at 706. If the generator 242 is off, the processor branches at 708 and continues to determine whether or not the generator 242 is on. If the generator 242 is on, the processor branches at 714 to determine if the second voltage V₂ is less than a predetermined over-voltage threshold V_{OV} and greater than a first predetermined voltage V_{C1} at 716. If the result of the comparison is negative, the processor branches at 712 and switches off the switch module 216 and turns off the voltage-booster circuit 240 at 710. The processor then branches at 778 and continues to determine whether or not the generator 242 is on. If the result of the comparison is true, the processor branches at 720 and determines whether or not the switch module 216 is on at 722. If the result of the comparison is negative, the processor branches at 724 and switches on the switch module 216 at 726 and branches at 730 to continue its operation. If the result of the comparison is positive, the processor branches at 728 to determine if the first electrical current I₁ is greater than or equal to a second predetermined electrical current I_{C2} at 734. If the result of the comparison is positive, the processor branches at 732 and continues to determine whether or not the generator 242 is on. If the result of the comparison is false, the processor branches at 738 to determine if the first electrical current I₁ is less than or equal to a first predetermined electrical current I_{C1} at 740. If the result of the comparison is negative, the processor branches at 736 to continue its operation. If the result of the comparison is positive, the processor branches at 742 to determine if the first voltage V₁ is greater than or equal to the first predetermined voltage V_{C1} at 750. If the result of the comparison is positive, the processor branches at 744 and continues to determine whether or not the generator 242 is on. If the result of the comparison is negative, the processor branches at 748 to switch off the switch module 216 and turn on the voltage-booster circuit 240 at 746. The processor branches at 752 and once again determines if the first electrical current I₁ is less than or equal to the first predetermined electrical current I_{C1} at 758. If the result of the comparison is positive, the processor branches at 760 and switches on the switch module 216 and turns off the voltage-booster circuit 240 at 756 and subsequently branches at 745 to determine whether or not the generator 242 is on. If the result of the comparison is negative, the processor branches at 762 to determine whether or not the generator 242 is on at 766. If the result of the comparison is false, the processor branches at 768 and switches off the switch module 216 and turns off the voltage-booster circuit 240 at 764 and subsequently branches at 780 to determine whether or not the generator 242 is on. If the result of the comparison is true, the processor branches at 770 to determine if the second voltage V₂ is less than the predetermined over-voltage threshold V_{OV} and greater than the first predetermined voltage V_{C1} at 772. If the result of the comparison is negative, the processor is branched at 774 to determine whether or not the generator 242 is on. If the result of the comparison is positive, the processor is branched at 776 to continue its operation.

The foregoing discloses an electrical system, such as a vehicle electrical system, including a battery charger operative to charge or otherwise deliver electrical power to an electrical subsystem via a switched-booster circuit. The electrical subsystem comprises a battery and an electrical load and the switched-booster circuit includes a switch module and a voltage-booster circuit. A control device, included in the electrical system, switches on and off the switch module to controllably bypass a voltage-booster circuit according to at least one of the voltage of the electrical subsystem and the electrical current through the switched-booster circuit. The electrical system may further include additional electrical subsystems and the control device may be further configured to control the voltage-booster circuit.

The foregoing explanations, descriptions, illustrations, examples, and discussions have been set forth to assist the reader with understanding this invention and further to demonstrate the utility and novelty of it and are by no means restrictive of the scope of the invention. It is the following claims, including all equivalents, which are intended to define the scope of this invention.

What is claimed is:

1. An electrical system, comprising:
(a) a first electrical subsystem;
(b) a switched-booster circuit comprising a switch module and a voltage-booster circuit wherein the switch module is coupled with the voltage-booster circuit;
(c) a battery charger coupled with the first electrical subsystem via the switched-booster circuit; and
(d) a control device coupled with at least one of the first electrical subsystem and switched-booster circuit;
wherein the control device is configured to:
(i) ascertain at least one of a first voltage of the first electrical subsystem and first electrical current through the switched-booster circuit; and
(ii) apply a control signal to the switch module according to at least one of the first voltage and first electrical current.

2. The system of claim 1, wherein the electrical system comprises a vehicle electrical system.

3. The system of claim 1, wherein the first electrical subsystem comprises at least one of a battery and an electrical load.

4. The system of claim 1, wherein the battery charger comprises a generator.

5. The system of claim 1, wherein the control signal comprises one of a step signal and a modulated signal.

6. The system of claim 5, wherein the step signal comprises one of a switch on and a switch off signal.

7. The system of claim 6, wherein the step signal is a switch on signal when the first voltage is greater than or equal to a first predetermined voltage and the first electrical current is less than a first predetermined electrical current.

8. The system of claim 6, wherein the step signal is a switch off signal when the first voltage is less than or equal to a first predetermined voltage and the first electrical current is greater than or equal to a first predetermined electrical current and less than or equal to a second predetermined electrical current.

9. The system of claim 6, wherein the step signal is a switch on signal when the first voltage is less than or equal to a first predetermined voltage and the first electrical current is greater than a second predetermined electrical current.

10. The system of claim 1, wherein the control device is further configured to control the voltage-booster circuit.

11. The system of claim 1, further comprising:
(e) a second electrical subsystem coupled with the battery charger.

12. The system of claim 11, wherein the second electrical subsystem comprises at least one of a battery and an electrical load.

13. A method for controlling an electrical system, said system comprising a first electrical subsystem, a switched-booster circuit comprising a switch module and a voltage-booster circuit wherein the switch module is coupled with the voltage-booster circuit, and a battery charger coupled with the first electrical subsystem via the switched-booster circuit, said method comprising:
(i) ascertaining at least one of a first voltage of the first electrical subsystem and first electrical current through the switched-booster circuit; and
(ii) applying a control signal to the switch module according to at least one of the first voltage and first electrical current.

14. The method of claim 13, further comprising:
(iii) controlling the voltage-booster circuit.

15. A control device coupled with at least one of a first electrical subsystem and a switched-booster circuit, said switched-booster circuit comprising a switch module and a voltage-booster circuit wherein the switch module is coupled with the voltage-booster circuit, and wherein a battery charger is coupled with the first electrical subsystem via the switched-booster circuit, said control device comprising:
(a) a controller;
wherein the controller is configured to:
(i) measure at least one of a first voltage of the first electrical subsystem and first electrical current through the switched-booster circuit, via at least one of a first sense line and a second sense line; and
(ii) apply a control signal, via a control line, to the switch module according to at least one of the first voltage and first electrical current.

16. The control device of claim 15, wherein the control signal comprises one of a step signal and a modulated signal.

17. The control device of claim 16, wherein the step signal comprises one of a switch on and a switch off signal.

18. The control device of claim 17, wherein the step signal is a switch on signal when the first voltage is greater than or equal to a first predetermined voltage and the first electrical current is less than a first predetermined electrical current.

19. The control device of claim 17, wherein the step signal is a switch off signal when the first voltage is less than or equal to a first predetermined voltage and the first electrical current is greater than or equal to a first predetermined electrical current and less than or equal to a second predetermined electrical current.

20. The control device of claim 17, wherein the step signal is a switch on signal when the first voltage is less than or equal to a first predetermined voltage and the first electrical current is greater than a second predetermined electrical current.

21. The control device of claim 15, wherein the control device is further configured to control the voltage-booster circuit.

22. The control device of claim 15, wherein the battery charger is further coupled with a second electrical subsystem.

23. A method for controlling a switched-booster circuit, said switched-booster circuit comprising a switch module and a voltage-booster circuit wherein the switch module is coupled with the voltage-booster circuit, and wherein a battery charger is coupled with the first electrical subsystem via the switched-booster circuit, said method comprising:
(i) measuring at least one of a first voltage of the first electrical subsystem and first electrical current through the switched-booster circuit, via at least one of a first sense line and a second sense line; and
(ii) applying a control signal, via a control line, to the switch module according to at least one of the first voltage and first electrical current.

24. The method of claim 23, further comprising:
(iii) controlling the voltage-booster circuit, via a controller.
